(19) United States
(12) Patent Application Publication
(10) Pub. No.: US 2026/0156704 A1
(43) Pub. Date: Jun. 4, 2026

(54) NETWORK ACCESS METHOD AND APPARATUS,UE, AND NETWORK SIDE DEVICE

(71) Applicant: VIVO MOBILE COMMUNICATION CO., LTD., Dongguan (CN)

(72) Inventors: Wenjuan PU, Dongguan (CN); Xiaodong YANG, Dongguan (CN); Zhihan HUANG, Dongguan (CN); Zhenhua XIE, Dongguan (CN); Xuanbing LIU, Dongguan (CN)

(73) Assignee: VIVO MOBILE COMMUNICATION CO., LTD., Dongguan, GD (CN)

(21) Appl. No.: 19/459,249

(22) Filed: Jan. 26, 2026

Related U.S. Application Data
(63) Continuation of application No. PCT/CN2024/106535, filed on Jul. 19, 2024.

(30) Foreign Application Priority Data
Jul. 25, 2023 (CN) 202310922935.4

(51) Int. Cl. H04W 76/20; H04W 24/10; H04W 76/10; H04W 84/04

(52) U.S. Cl. CPC H04W 76/20; H04W 24/10; H04W 76/10; H04W 84/042

(57) ABSTRACT

A network access method includes: when a UE has established a first radio resource control (RRC) connection, receiving first signaling from a network side device, wherein the first signaling is used for instructing the UE to execute a dual steering operation, and the dual steering operation is to establish a second RRC connection for the UE.

### CROSS-REFERENCE TO RELATED APPLICATIONS

This application is a continuation of International Application No. PCT/CN2024/106535, filed on Jul. 19, 2024, which claims priority to Chinese Patent Application No. 202310922935.4, filed in China on Jul. 25, 2023, which is incorporated herein by reference in its entirety.

### TECHNICAL FIELD

This application relates to the field of communication technologies, and in particular, to a network access method and apparatus, a user equipment (UE), and a network side device.

### BACKGROUND

With the development of network technologies, in a case that a user equipment (UE) has established first access, a network side device may expect, based on a network policy when a network is congested, that the UE initiates second access at a specific node. However, the UE cannot determine whether the network is congested and cannot learn a network policy. Therefore, the UE does not know a cell on which the second access is initiated. If the UE may autonomously select a cell to initiate the second access, the second access may fail or a relatively large delay occurs.

### SUMMARY

Embodiments of this application provide a network access method and apparatus, a UE, and a network side device, to improve a success rate of establishing a second radio resource control (RRC) connection and reduce a delay of the second RRC connection when the UE has established a first RRC connection.

According to a first aspect, a network access method is provided, which is performed by a UE. The method includes: receiving first signaling from a network side device when a UE has established a first radio resource control RRC connection. The first signaling is used to instruct the UE to perform a dual steering operation. The dual steering operation is used to establish a second RRC connection for the UE.

According to a second aspect, a network access method is provided. The method is performed by a network side device. The method includes: The network side device sends first signaling to a UE when the UE has established a first RRC connection. The first signaling is used to instruct the UE to perform a dual steering operation. The dual steering operation is used to establish a second RRC connection for the UE.

According to a third aspect, a network access apparatus is provided. The apparatus is applied to a UE. The apparatus includes a receiving module. The receiving module is configured to receive first signaling from a network side device when the UE has established a first radio resource control RRC connection. The first signaling is used to instruct the UE to perform a dual steering operation. The dual steering operation is used to establish a second RRC connection for the UE.

According to a fourth aspect, a network access apparatus is provided, which is applied to a network side device. The apparatus includes a sending module. The sending module is configured to send first signaling to a UE when the UE has established a first RRC connection. The first signaling is used to instruct the UE to perform a dual steering operation. The dual steering operation is used to establish a second RRC connection for the UE.

According to a fifth aspect, a UE is provided. The terminal includes a processor and a memory. The memory stores a program or an instruction executable in the processor. The program or the instruction, when executed by the processor, implements the steps of the method in the first aspect.

According to a sixth aspect, a UE is provided, including a processor and a communication interface. The communication interface is configured to receive first signaling from a network side device when the UE has established a first radio resource control RRC connection. The first signaling is used to instruct the UE to perform a dual steering operation. The dual steering operation is used to establish a second RRC connection for the UE.

According to a seventh aspect, a network side device is provided. The network side device includes a processor and a memory. The memory stores a program or an instruction executable in the processor. The program or the instruction, when executed by the processor, implements the steps of the method in the first aspect.

According to an eighth aspect, a network side device is provided, including a processor and a communication interface. The communication interface is configured to send first signaling to a UE when the UE has established a first RRC connection. The first signaling message is used to instruct the UE to perform a dual steering operation. The dual steering operation is used to establish a second RRC connection for the UE.

According to a ninth aspect, a readable storage medium is provided. The readable storage medium stores a program or an instruction. The program or the instruction, when executed by a processor, implements the steps of the method in the first aspect or implements the steps of the method in the second aspect.

According to a tenth aspect, a wireless communication system is provided, including a terminal and a network side device. The terminal may be configured to perform the steps of the method in the first aspect. The network side device may be configured to perform the steps of the method in the second aspect.

According to an eleventh aspect, a chip is provided. The chip includes a processor and a communication interface. The communication interface is coupled to the processor. The processor is configured to run a program or an instruction to implement the method in the first aspect, or implement the method in the second aspect.

According to a twelfth aspect, a computer program/program product is provided. The computer program/program product is stored in a storage medium. The program/program product is executed by at least one processor to implement the method in the first aspect, or to implement the method in the second aspect.

In embodiments of this application, when the UE has established the first RRC connection, the first signaling is received from the network side device. The first signaling is used to instruct the UE to perform the dual steering operation. The dual steering operation is used to establish the second RRC connection for the UE. In this way, when a resource is congested, the network side device may instruct or request, in time through the first signaling, the UE to perform the dual steering operation. The UE performs the second RRC connection based on the signaling, to improve a success rate of the second RRC connection and reduce an establishment delay of the second RRC connection.

### BRIEF DESCRIPTION OF THE DRAWINGS

FIG. 1 is a possible schematic structural diagram of a communication system involved in an embodiment of this application;

FIG. 2 is a schematic flowchart I of a network access method according to an embodiment of this application;

FIG. 3 is a schematic flowchart II of a network access method according to an embodiment of this application;

FIG. 4 is a schematic flowchart III of a network access method according to an embodiment of this application;

FIG. 5 is a schematic flowchart IV of a network access method according to an embodiment of this application;

FIG. 6 is a schematic flowchart V of a network access method according to an embodiment of this application;

FIG. 7 is a schematic flowchart VI of a network access method according to an embodiment of this application;

FIG. 8 is a schematic flowchart VII of a network access method according to an embodiment of this application;

FIG. 9 is a schematic structural diagram I of a network access apparatus according to an embodiment of this application;

FIG. 10 is a schematic structural diagram II of a network access apparatus according to an embodiment of this application;

FIG. 11 is a schematic structural diagram III of a network access apparatus according to an embodiment of this application;

FIG. 12 is a schematic structural diagram IV of a network access apparatus according to an embodiment of this application;

FIG. 13 is a schematic structural diagram V of a network access apparatus according to an embodiment of this application;

FIG. 14 is a schematic diagram of a hardware structure of a communication device according to an embodiment of this application;

FIG. 15 is a schematic diagram of a hardware structure of a terminal according to an embodiment of this application; and

FIG. 16 is a schematic diagram of a hardware structure of a network side device according to an embodiment of this application.

### DETAILED DESCRIPTION

Technical solutions in embodiments of this application are clearly described below with reference to the accompanying drawings in embodiments of this application. Apparently, the described embodiments are merely some rather than all embodiments of this application. All other embodiments obtained by a person of ordinary skill in the art based on embodiments of this application fall within the protection scope of this application.

Terms “first”, “second”, and the like in this application are used to distinguish between similar objects rather than describe a specific order or sequence. It should be understood that the terms used in this case may be transposed where appropriate, so that embodiments of this application may be implemented in a sequence other than those illustrated or described herein. In addition, objects defined by “first” and “second” are generally of the same class and do not limit a quantity of objects. For example, one first object may be arranged, or a plurality of objects may be arranged. In addition, “or” in this application indicates at least one of connected objects. For example, “A or B” encompasses three solutions: solution I: A is included but B is not included; solution II: B is included but A is not included; and solution III: both A and B are included. A character “/” generally indicates an “or” relationship between associated objects.

A term “indication” in this application may be a direct indication (or an explicit indication) or an indirect indication (or an implicit indication). The direct instruction may be understood as that a sending party clearly informs a receiving party of specific information, an operation to be performed, or a request result in the sent instruction. The indirect indication may be understood as that the receiving party determines corresponding information based on an indication sent by the sending party, or makes a determination and determines, based on a determining result, an operation that needs to be performed or a request result.

Technical terms involved in the technical solutions provided in embodiments of this application are described below:

### Dual Steering

Dual steering is a characteristic that a core network aggregates two pieces of 3GPP access to provide transmission for a UE.

In the following scenarios, a network may want to aggregate 2 pieces of 3GPP access, to improve performance such as network resource utilization, UE communication reliability, and quality of experience (QoE) of a user.
1) Different radio access technologies (RAT) of one public land mobile network (PLMN), the PLMN not supporting eNB NR Dual Connectivity (EN-DC), or NR eNB Dual Connectivity (NE-DC).
2) PLMN1+PLMN2/non-public network (NPN), and radio access network (Radio Access Network, RAN) sharing cannot be used. For example, when a large-scale sport event or activity is held in a stadium, a PLMN2/NPN is used to provide an additional network resource.
3) Access to 2 non-terrestrial networks (NTN).
4) NTN+terrestrial network (TN), where the NTN provides an additional resource for the TN.

It should be noted that the technology described in embodiments of this application may be applied to a long term evolution (LTE)/LTE-advanced (LTE-A) system, and may be further applied to another wireless communication system, such as a code division multiple access (CDMA) system, a time division multiple access (TDMA) system, a frequency division multiple access (FDMA) system, an orthogonal frequency division multiple access (OFDMA) system, a single-carrier frequency division multiple access (SC-FDMA) system, or another system. Terms “system” and “network” in embodiments of this application are usually interchangeably used, and the described technology may be used for both the system and the radio technology mentioned above, or may be used for another system and another radio technology. A new radio (NR) system is described below as an example, and the term NR is used in most of the following description. Nevertheless, the technologies may also be applied to a system other than the NR system, such as a 6^{th} generation (6G) communication system.

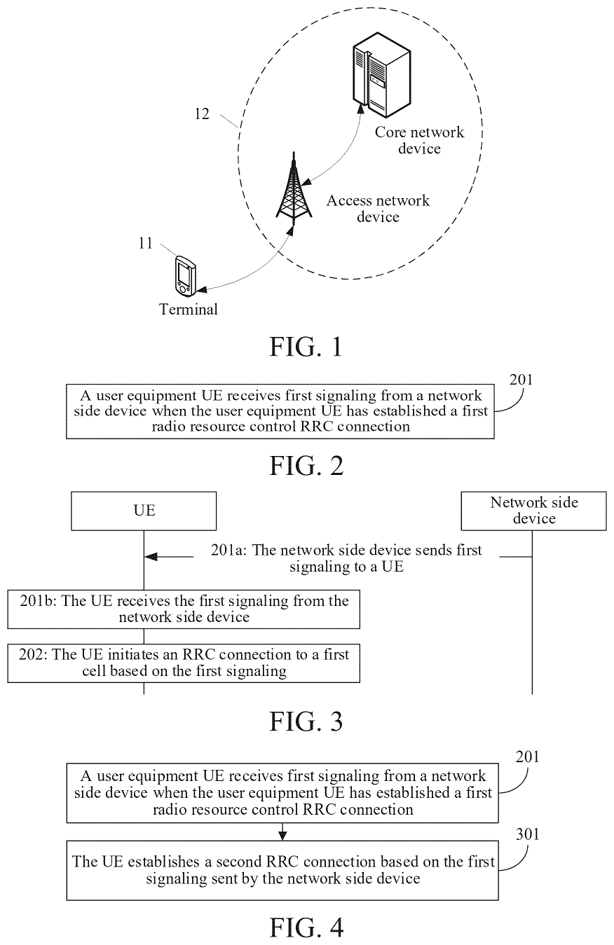

FIG. 1 is a block diagram showing a wireless communication system to which an embodiment of this application may be applied. The wireless communication system includes a terminal 11 and a network side device 12. The terminal 11 may be a terminal side device such as a mobile phone, a tablet computer, a laptop computer, a notebook computer, a personal digital assistant (PDA), a palmtop computer, a netbook, an ultra-mobile personal computer (UMPC), a mobile internet device (MID), an augmented reality (AR), a virtual reality (VR) device, a robot, a wearable device, a flight vehicle, an Vehicle User Equipment (VUE), a shipborne device, a Pedestrian User Equipment (PUE), a smart home appliance (a home device with a wireless communication capability, such as a refrigerator, a television, a washing machine, or furniture), a game console, a personal computer (PC), a teller machine, or a self-service machine. The wearable device includes a smart watch, a smart bracelet, a smart headset, smart glasses, smart jewelry (a smart bracelet, a smart chain bracelet, a smart ring, a smart necklace, a smart ankle bangle, a smart ankle chain, and the like), a smart wristband, smart clothing, and the like. The on-board device may also be referred to as an on-board terminal, an on-board controller, an on-board module, an on-board component, an on-board chip, an on-board unit, or the like. It should be noted that a specific type of the terminal 11 is not limited in this embodiment of this application. The network side device 12 may include an access network device or a core network device. The access network device may also be referred to as a radio access network (RAN) device, a wireless access network function, or a wireless access network unit. The access network device may include a base station, a wireless local area network (WLAN) access point (AS), a wireless fidelity (Wi-Fi) node, or the like. The base station may be referred to as a node B (NB), an evolved Node B (eNB), a next generation Node B (gNB), a new radio Node B (NR Node B), an access point, a relay base station (RBS), a serving base station (SBS), a base transceiver station (BTS), a radio base station, a radio transceiver, a basic service set (BSS), an extended service set (ESS), a home node B (HNB), a home evolved node B, a Transmission Reception Point (TRP), or another appropriate term in the art. The base station is not limited to a specific technical term, as long as the same technical effect can be achieved. It should be noted that, in this embodiment of this application, only a base station in an NR system is used as an example for description, and a specific type of the base station is not limited.

The core network device may include, but is not limited to, at least one of the following: a core network node, a core network function, a mobility management entity (MME), an access and mobility management function (AMF), a session management function (SMF), a user plane function (UPF), a policy control function (PCF), a policy and charging rules function (PCRF), an edge application server discovery function (EASDF), unified data management (UDM), a unified data repository (UDR), a home subscriber server (HSS), a centralized network configuration (CNC), a network repository function (NRF), a network exposure function (NEF), a local NEF (L-NEF), a binding support function (BSF), an application function (AF), and the like. It should be noted that in embodiments of this application, only the core network device in the NR system is used as an example, and a specific type of the core network device is not limited. However, the core network device is not limit to at least one of the following: a core network node, a core network function, a mobility management entity (MME), an access and mobility management function (AMF), a session management function (SMF), a user plane function (UPF), a policy control function (PCF), a policy and charging rules function (PCRF), an edge application server discovery function (EASDF), unified data management (UDM), a unified data repository (UDR), a home subscriber server (HSS), a centralized network configuration (CNC), a network repository function (NRF), a network exposure function (NEF), a local NEF (L-NEF), a binding support function (BSF), an application function (AF), and the like. It should be noted that in embodiments of this application, only the core network device in the NR system is used as an example, and a specific type of the core network device is not limited.

The network access method, the UE, and the network side device provided in embodiments of this application are described in detail below through some embodiments and application scenarios thereof with reference to the drawings.

It should be noted that the network side device provided in embodiments of this application may be a base station, or may be a core network device.

FIG. 2 is a schematic flowchart of a network access method according to an embodiment of this application. As shown in FIG. 2, the network access method may include the following step 201.

Step 201: A user equipment UE receives first signaling from a network side device when the UE has established a first radio resource control RRC connection.

In this embodiment of this application, the foregoing first signaling is used to instruct the UE to perform a dual steering operation.

For example, the foregoing first signaling may be a display indication. For example, the foregoing first signaling may include indication information. The indication information is used to directly instruct the UE to perform the dual steering operation.

For example, the foregoing first signaling may also be an implicit indication. For example, the foregoing first signaling may include configuration information or auxiliary information. The UE performs the dual steering operation after determining, based on the configuration information or the auxiliary information, a cell to which a second RRC connection is initiated.

In this embodiment of this application, the foregoing dual steering operation is used to establish the second RRC connection for the UE.

Optionally, in embodiments of this application, with reference to FIG. 2 and as shown in FIG. 3, in the network access method provided in embodiments of this application, step 201 above further includes step 201a and step 201b below.

Step 201a: The network side device sends the first signaling to the UE.

Step 201b: The UE receives the first signaling from the network side device.

In this embodiment of this application, the foregoing first signaling may be medium access control control element (MAC CE) signaling, or may be RRC signaling, non-access stratum (NAS) signaling, physical layer signaling, or the like, which is not limited in this embodiment of this application.

It should be noted that the foregoing first RRC connection and the second RRC connection may also be understood as first 3GPP access and second 3GPP access, or may be understood as a first network connection and a second network connection. After establishing the RRC connection, the UE further needs to establish an NAS connection to a core network. Therefore, step 201 may alternatively be understood as that the UE establishes the second RRC connection between the UE and the base station after receiving the first signaling from the network side device when the UE has established the first NAS connection, and establishes the NAS connection between a base station corresponding to the second RRC connection and the core network.

In this embodiment of this application, if the foregoing first signaling is the RRC signaling, the MAC CE, or the physical layer signaling and is sent by the base station to the UE, the base station may first receive, from the core network, the configuration information or the auxiliary information related to the first signaling before the base station sends the first signaling. If the first foregoing signaling is the NAS signaling and is sent to the UE by the core network, a UE NAS layer sends the first signaling to a UE AS layer after the first signaling is received when necessary.

In the network access method provided in embodiments of this application, when the UE has established the first RRC connection, the first signaling is received from the network side device. The first signaling is used to instruct the UE to perform the dual steering operation. The dual steering operation is used to establish a second RRC connection for the UE. In this way, when a resource is congested, the network side device may instruct or request, in time through the first signaling, the UE to perform the dual steering operation. The UE performs the second RRC connection based on the signaling, to improve a success rate of the second RRC connection and reduce an establishment delay of the second RRC connection.

Optionally, in embodiments of this application, with reference to FIG. 2 and as shown in FIG. 4, after step 201 above, the network access method provided in embodiments of this application further includes step 301.

Step 301: The UE establishes the second RRC connection based on the first signaling sent by the network side device.

It should be noted that the UE initiates the second RRC connection based on the dual steering operation indicated by the first signaling when the UE has established the first RRC connection.

Optionally, in this embodiment of this application, step 301 above specifically includes step 301a.

Step 301a: The UE sets an RRC connection cause value to a first value when the second RRC connection is initiated.

In this embodiment of this application, the RRC connection cause value includes an RRC connection establishment cause value or an RRC connection resume cause value.

In this embodiment of this application, the foregoing first value is at least one of the followings:
a cause value related to a dual steering mode; or
a cause value related to a mobile originated call.

In a possible embodiment, the foregoing first signaling may be a display indication. For example, the foregoing first signaling may include indication information. The indication information is used to directly instruct or request the UE to initiate the second RRC connection.

Optionally, in this embodiment of this application, the foregoing first signaling includes first indication information.

For example, the first indication information is used to instruct or request the UE to initiate the second RRC connection.

Further, optionally, in this embodiment of this application, before the UE establishes, based on the first signaling sent by the network side device, the second RRC connection, the UE searches for a cell that satisfies a second condition, and the UE initiates the second RRC connection to the cell that satisfies the second condition.

In this embodiment of this application, the foregoing cell that satisfies the second condition includes at least one of the followings:
a suitable cell;
a cell supporting dual steering;
a cell supporting UE capability change; or
a cell having a PLMN supporting dual steering.

For example, when a cell supports the dual steering, the UE determines that the cell is the cell that satisfies the second condition, and initiates the second RRC connection to the cell. Alternatively, when a cell supports the change in the capability, the UE determines that the cell is the cell that satisfies the second condition, and initiates the second RRC connection to the cell.

Optionally, in a case that the core network and the base station are simultaneously upgraded to support the dual steering, the base station may directly instruct the UE to initiate the second RRC connection when the base station finds that dual connectivity (DC) cannot be aggregated (namely, no available SN exists). Alternatively, the core network sends a request to the base station, for example, through a UE registration process, or a non-UE-related process, and then the request is sent by the base station to the UE.

In this way, after receiving the first signaling, the UE may immediately initiate the second RRC connection based on the first signaling, thereby reducing a delay in a second access process.

In another possible embodiment, a network side device informs, by sending the first signaling to the UE, a condition for the UE to initiate the second RRC connection.

Optionally, in this embodiment of this application, the first signaling includes second indication information, and the second indication information is used to indicate a condition for the UE to initiate the second RRC connection.

For example, when the UE satisfies the condition for initiating the second RRC connection, the UE directly initiates the second RRC connection.

For example, the condition for the UE to initiate the second RRC connection may include at least one of the following:
a time delay of data transmission of the first RRC connection established by the UE is greater than a first preset threshold;
congestion occurs on data transmission of a current network side device; or
a transmission data volume is greater than a second preset threshold.

The foregoing first preset threshold and the foregoing second preset threshold may be configured on a network side, or may be agreed on by a protocol.

In an example, when a data volume currently transmitted by the UE is greater than the second preset threshold, the UE initiates the second RRC connection. In this way, the UE may initiate the second RRC connection after receiving first signaling and when the condition for the UE to initiate the second RRC connection indicated by the first signaling is satisfied, so as to initiate the second RRC connection as soon as possible when the UE currently has established the first RRC connection.

In another possible embodiment, the network side device may send, to the UE, configuration information used to assist the UE in initiating the RRC connection to the first cell. Then, the UE determines the first cell based on the configuration information sent by the network side device and initiates the RRC connection to the first cell.

Optionally, in this embodiment of this application, the foregoing first signaling includes first configuration information.

In this embodiment of this application, the foregoing first configuration information is used to assist the UE to determine the first cell to which the RRC connection is initiated.

In this embodiment of this application, the first configuration information may further include at least one of the following:
a type of a RAT of a cell;
a frequency of the cell;
ID information of the cell;
a cell type;
PLMN information;
NPN information; or
network capability information of the cell.

For example, the foregoing ID information of the cell may be a physical cell identifier (PCI) or an NR cell global identifier (NCGI).

Optionally, in this embodiment of this application, the foregoing network capability information of the cell includes at least one of the following:
first information indicating that the cell supports the dual steering operation; or
second information indicating that the cell supports UE capability change.

For example, when the foregoing network capability information of the cell includes the first information indicating that the cell supports the dual steering operation, it indicates that a cell supports the dual steering operation, and the UE may use the cell as a first cell. Alternatively, when the foregoing network capability information of the cell includes the second information indicating that the cell supports the change in the capability of the UE, it indicates that a cell supports the change in the capability of the UE, and the UE may use the cell as the first cell.

For example, the foregoing first configuration information may be directly sent to the UE by the core network, or may be sent to the UE by the base station. If the information is sent by the base station to the UE, the base station may send a related parameter received from the core network function to the UE as the first configuration information, for example, a frequency list or a cell list. Alternatively, the base station may deduce the first configuration information based on the related parameter received from the core network function, and send the first configuration information to the UE.

It should be noted that, one or more configurations in the foregoing first configuration information may exist. For example, cell ID information in the first configuration information may include one or more cell IDs. The frequency of the cell in the first configuration information may include frequencies of one or more cells. The network capability information of the cell may be network capability information of one or more cells.

Optionally, in this embodiment of this application, the network access method provided in embodiments of this application further includes step 401.

Step 401: The UE uses the cell that satisfies the first configuration information as the first cell, or uses a corresponding cell of cell ID information as the first cell when the first configuration information includes the cell ID information.

It should be noted that the foregoing first cell may not be a serving cell of a current first RRC connection of the UE.

Optionally, the UE uses a cell that satisfies the foregoing first configuration information as the first cell. For example, when a type of a RAT of a cell is the same as one of RAT types of the cell configured by the first configuration information, the UE uses the cell as the first cell, and initiates the second RRC connection to the first cell. Alternatively, when a frequency of a cell is the same as one of the frequencies of the cell configured by the first configuration information, the cell is used as the first cell. When a cell identifier ID of a cell is the same as one of pieces of cell identifier ID information configured by the first configuration information, the cell is used as the first cell. Alternatively, when a cell type of a cell is the same as one of cell types configured by the first configuration information, the cell is used as the first cell. Alternatively, when a PLMN of a cell is the same as one of pieces of PLMN information configured by the first configuration information, the cell is used as the first cell. Alternatively, when NPN information of a cell is the same as one of pieces of NPN information configured by the first configuration information, the cell is used as the first cell. Alternatively, when the cell network capability information configured by the first configuration information indicates that the cell supports the dual steering operation, a cell is used as the first cell when the cell supports the dual steering operation. Alternatively, the cell network capability information configured by the first configuration information indicates that a cell supports the change in the capability of the UE. When a cell supports the change in the capability of the UE, the cell is used as the first cell.

Optionally, the UE initiates the second RRC connection by using a cell conforming to the first configuration information as a high-priority cell, or the UE initiates the second RRC connection only to the cell conforming to the first configuration information.

Optionally, the network side device may carry information of the first cell in the first configuration information. The information of the first cell is used to accelerate establishment of the second RRC connection by the UE. For example, the information of the first cell may be a broadcast message of the first cell. In this way, the UE directly uses the broadcast message in the first configuration information initiating the second RRC connection on the first cell, and does not need to read the broadcast message of the first cell, thereby reducing a delay of the second RRC access.

Optionally, when the first configuration information includes cell ID information, the UE directly initiates the second RRC connection by using a cell corresponding to the cell ID information as the first cell.

In this way, the UE may preferentially select, based on the configuration message sent by the network side device to assist the UE to initiate the RRC connection to the first cell, the cell conforming to the first configuration information, and perform the second RRC connection, thereby improving a success rate of second access of the UE when the UE currently accesses the serving cell.

Optionally, in embodiments of this application, the foregoing first signaling includes second configuration information.

In embodiments of this application, the foregoing second configuration information includes at least one of the followings:
third information used to indicate that the network side device supports the dual steering operation; or
fourth information used to indicate a session steering mode used to perform the dual steering operation.

Specifically, the session steering mode may also be a dual steering mode, and may include at least one of the following.
1) Active-standby switching (Active-standby): A service data flow (SDF) is switched to another available access when active access is unavailable; and switched back when the active access is available again.
2) Smallest delay: The SDF is switched to access of a shortest radio transfers technology (RTT). RTTs of a 3GPP and a non-3GPP are obtained by measurement of the UE and a user plane function (UPF).
3) Load-balancing: when two pieces of access are both available, data distribution may be implemented on the two pieces of access. Transmission data are sent between two pieces of access based on an SDF traffic percentage. The load-balancing is only used for a non-guaranteed bit rate (Non-GBR) SDF.
4) Priority-based: Transmission may be preferentially performed on high-priority access. When the access is congested, data may be transmitted on low-priority access in a split manner. How the UE and the UPF determine whether the high-priority access is congested is based on implementation.
(2), (3), and (4) are only used for the Non-GBR SDF. When a preferential one is access unavailable, another access is used.
5) Redundant: data is duplicated in two pieces of access.

The condition of sending the foregoing first signaling to the UE is described in detail below through two possible embodiments.

In a first possible embodiment, the UE actively sends a request to the network side device, so that the network side device sends the first signaling to the UE based on the request.

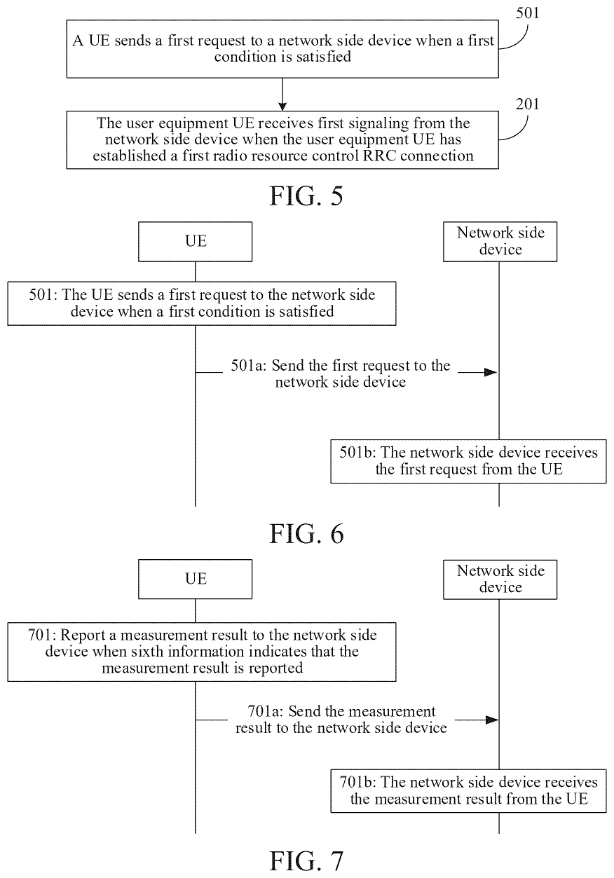

Optionally, in embodiments of this application, with reference to FIG. 2 and as shown in FIG. 5, when the first signaling includes the first configuration information, before step 201 above, the network access method provided in embodiments of this application further includes step 501.

Step 501: The UE sends a first request to the network side device when a first condition is satisfied.

In embodiments of this application, the first request is used to request the network side device to send the first signaling.

Optionally, the foregoing first signaling may include the first configuration information or the second configuration information.

In embodiments of this application, the foregoing first condition includes at least one of the followings:
the UE is in a single-access state and requests to enter a dual steering mode; or
the UE is in a dual steering mode and requests to resume from an abnormal dual steering transmission.

Optionally, the foregoing single-access state is that the UE currently has only one RRC connection. Alternatively, the UE currently has only one RRC entity.

Optionally, that “the UE is in a single-access state and requests to enter a dual steering mode” above is used to represent that the UE requests to establish the second RRC connection when the UE currently has only one RRC connection. The UE may be considered to enter the dual steering mode after the UE successfully initiates the second RRC connection or after the core network receives the NAS signaling of the UE through the second RRC connection. In this case, the UE sends the first request to the network side device, so that after receiving the first request, the network side device sends first signaling to the UE to assist the UE in rapidly finding a suitable cell to perform the second RRC connection when requesting to establish the second RRC connection for the first time.

Optionally, that “the UE is in a dual steering mode and requests to resume from an abnormal dual steering transmission” above is used to indicate that when the UE is in the dual steering mode, the UE initiates re-establishment after a radio link failure occurs for certain access, and the UE needs to perform cell selection in a re-establishment process. In this case, the UE sends the first request to the network side device, to inform the network side device that another access of the UE experiences a transmission failure or is abnormal or is in an unreachable state, and then triggers the network side device to send the first signaling to the UE, to help the UE rapidly find a suitable cell to resume the access in the re-establishment process.

Optionally, in embodiments of this application, with reference to FIG. 5 and as shown in FIG. 6, in the network access method provided in embodiments of this application, step 501 above further includes step 501a and step 501b below.

Step 501a: The UE sends the first request to the network side device.

Step 501b: The network side device receives the first request from the UE.

Optionally, the network side device may indicate whether the UE allows sending the first request to the network side device.

In embodiments of this application, the foregoing first request is used by the UE to request the network side device to send the first signaling.

In this way, the UE may actively request the network side device to send the first signaling (for example, the first configuration information) when the first condition is satisfied, so that the UE can rapidly find the suitable cell based on the first signaling, and initiate the RRC connection on the cell, thereby reducing a time delay in an access process.

In a second possible embodiment, the foregoing first signaling may be sent to a UE by a base station based on a fifth instruction sent by a core network function.

Optionally, the foregoing fifth instruction includes at least one of the following:
third indication information, where the third indication information is used to indicate an event or a condition for the UE to enable/perform dual steering;
fourth indication information, where the fourth indication information is used to indicate a target mode of the UE in the dual steering; or
fifth indication information, where the fifth indication information is used to instruct the UE to perform the dual steering.

Optionally, when the fifth instruction includes the third indication information, the event or the condition for the UE to enable/perform dual steering may be network congestion. In other words, when the network is congested, the base station sends the first signaling to the UE.

For example, when the network congestion occurs in a serving cell to which the UE is currently connected, and the UE has a relatively large data transmission requirement, the network may consider using available resources of another cell to provide data transmission for the UE. In this case, the core network function sends the fifth instruction to the base station. The base station sends, based on the fifth instruction, the first instruction to the UE to instruct the UE to initiate the second RRC connection. Otherwise, the UE may not actively initiate the second RRC connection, or initiate the second RRC connection later. Then, the base station immediately sends the first signaling to the UE. The UE initiates the second RRC connection to another cell based on the first signaling.

Optionally, when the fifth instruction includes the fourth indication information, the base station instructs the UE to be in the target mode of the dual steering.

Optionally, the foregoing target mode includes at least one of the following: a Load-balance mode, an Active-standard mode, a Smallest delay mode, or a Priority-based mode.

Specifically, for the Load-balancing mode, when two pieces of access are both available, data distribution may be implemented on the two pieces of access. Transmission data is sent between two pieces of access based on an SDF traffic percentage. The mode is only used for the Non-GBR SDF.

The Active-standby mode: When active access is not available, an SDF is switched to another available access, and switched back when the active access is available again.

The Smallest delay mode: The SDF is switched to access having a shortest RTT. RTTs of the 3GPP and the non-3GPP are obtained by measurement of the UE and the UPF.

The Priority-based mode: Transmission may be preferentially performed on high-priority access. When the access is congested, data may be transmitted on low-priority access in a split manner. How the UE and the UPF determine whether the high-priority access is congested is based on implementation.

It should be noted that the Smallest delay mode, the Load-balancing mode, and the Priori-based mode are only used for the Non-GBR SDF. When a preferential one is access unavailable, another access is used.

For example, the base station sends the first configuration information to the UE based on the fifth instruction sent by the core network. After the UE receives the first configuration information and initiates a second connection based on the first configuration information, the base station releases the first connection (for example, the foregoing target mode includes the active-standby) or continues to maintain the first connection (for example, the foregoing target mode does not include the load balance). When the foregoing target mode includes the priority-based, the base station decides, based on a priority connection, whether to immediately enable the dual steering or during the congestion (for example, if the first connection has the highest priority, the dual steering is enabled during the congestion. If the second connection has the highest priority, the dual steering is immediately enabled).

In this way, the base station may send the first configuration information to the UE based on the instruction sent by the core network function, so that the UE can rapidly find the suitable cell based on the first configuration information and perform the RRC connection on the cell, thereby reducing a delay in the access process.

Optionally, in embodiments of this application, the foregoing first signaling is further used to indicate at least one of the following:
the UE performs dual steering measurement; or
the UE reports a measurement result of the dual steering measurement.

Further, optionally, in embodiments of this application, the first signaling further includes third configuration information.

In embodiments of this application, the foregoing third configuration information includes at least one of the following:
measurement interval gap configuration information for performing the dual steering measurement;
fifth information indicating a measurement object;
sixth information indicating whether a measurement result of dual steering is reported; or
a condition for reporting the measurement result.

When the terminal needs to use a hardware resource when performing dual steering measurement, the hardware resource may be used to perform data transmission on the first access. In this case, the measurement on second access and the data transmission on the first access conflict. Therefore, a network side may configure a measurement interval gap configuration used for performing dual steering measurement. The gap configuration may be a time interval, may be periodic, or may be non-periodic. After receiving the gap configuration, the UE performs dual steering measurement within the time interval indicated by the gap. Within the time range, the UE may not perform data transmission on the first access, for example, does not monitor PDCCH scheduling, or does not perform some uplink transmission. When not within this gap time interval, the UE needs to continue to monitor network scheduling on the first access.

Optionally, the foregoing measurement object may include at least one of the following: a RAT, a frequency, a cell, a reference signal type, or a reference signal resource.

For example, the network side device may instruct the UE to measure NR frequencies 1, 2, 3, and perform SSB measurement based on SS/PBCH block measurement timing configuration (SMTC) of the frequencies 1, 2, 3.

Optionally, the foregoing measurement result may be a result obtained after the UE performs measurement on the measurement object. The network side device may instruct the UE to report measurement results for reference signal received power (RSRP), reference signal received quality (RSRQ), and signal-to-noise and interference ratio (SINR). The network side device may also instruct the UE to report a measurement result of a cell level and a measurement result of a beam level. The network side device may alternatively instruct the UE to report a derivation manner of the measurement result of the cell level. For example, the network side device instructs the UE to derive the measurement result of the cell level based on measurement results of N pieces of beam exceeding a quality threshold X.

Optionally, the foregoing condition for reporting the measurement result may be a predefined event (for example, signal quality reaches a preset threshold) or periodic reporting. In addition, to control signaling overhead reported by the UE, the network side device may further limit the UE to only report a measurement result of a specific object, or not report a measurement result of a specific object.

In this way, the UE may perform dual steering measurement based on the first signaling indication. After obtaining the measurement result, the UE may determine the target cell based on the measurement result, and initiate the second RRC connection to the cell, so as to reduce a delay of performing the second RRC connection by the UE.

Whether the measurement result is reported to the network side device is described in detail below through two possible embodiments.

In a first possible embodiment, the third configuration information includes the foregoing sixth information. The sixth information indicates that the measurement result does not need to be reported to the network side device. The UE can directly determine, based on the measurement result from cells on which the measurement is performed, the second cell to which the UE can be connected, and initiate the second RRC connection to the second cell.

Further, optionally, in embodiments of this application, the network access method provided in embodiments of this application further includes step 601.

Step 601: The UE determines a second cell based on the measurement result when the foregoing sixth information indicates that the measurement result is not reported.

Optionally, the foregoing second cell may be a cell other than a serving cell to which the UE currently establishes the first RRC connection.

Optionally, the foregoing sixth information is used to indicate whether the measurement result is reported, and may be an implicit indication. For example, when the sixth information is not configured in the third configuration information or does not occur in the received first signaling, it indicates that the network side configures that the UE does not report the measurement result.

Optionally, the foregoing sixth information is used to indicate whether the measurement result is reported, and may be an explicit indication. For example, the sixth information is directly configured in the foregoing third configuration information to indicate that the measurement result is reported, or to indicate that the measurement result is not reported.

For example, if the measurement result does not need to be reported, the UE may determine the second cell from the measured cells based on the measurement result, so that the UE may initiate the second RRC connection to the second cell.

Optionally, after the UE receives the third configuration information, the UE preferentially measures the measurement object indicated in the third configuration information. If the sixth information indicates that the measurement result is not reported, the UE may determine the second cell based on the measurement result, and initiate the second access on the second cell. If the UE finds, after measurement, that a measurement result of a measurement object indicated in the third configuration information is not good enough, for example, does not satisfy a camping condition, the UE may perform measurement on the measurement object except the third configuration information, to find a suitable cell to initiate the second access.

In this way, after completing measurement to obtain the measurement result, the UE can quickly select, based on the measurement result, a suitable cell on which the UE performs the second RRC connection, thereby reducing a time delay in a process of performing second RRC access procedure by the UE.

In a second possible embodiment, third configuration information includes the foregoing sixth information. The sixth information indicates that the measurement result needs to be reported to the network side device. The network side device determines, based on the measurement report reported by the UE, the second cell to which the UE can initiate the second RRC connection.

Optionally, in this embodiment of this application, the network access method provided in embodiments of this application further includes step 701.

Step 701: The UE reports the measurement result to the network side device when the sixth information indicates that the measurement result is reported.

Optionally, in embodiments of this application, as shown in FIG. 7, in the network access method provided in embodiments of this application, step 701 above further includes step 701a and step 701b below.

Step 701a: The UE sends the measurement result to the network side device.

Step 701b: The network side device receives the measurement result from the UE.

Optionally, the foregoing measurement result is used to determine the second cell.

Optionally, in embodiments of this application, after step 701 above, the network access method provided in embodiments of this application further includes step 801.

Step 801: The UE receives fourth signaling from the network side device.

Optionally, the foregoing fourth signaling may be sent by the network side device through the NAS message or the RRC signaling.

In embodiments of this application, the foregoing fourth signaling is used to instruct the UE to report the fourth configuration information of the second cell.

In embodiments of this application, the foregoing fourth configuration information includes at least one of the following:
ID information of the second cell;
a RAT type of the second cell;
frequency information of the second cell;
PLMN information of the second cell;
a type of the second cell;
signal quality of the second cell;
a broadcast message of the second cell; or
network capability information of the second cell.

Optionally, in embodiments of this application, after the UE receives the fourth signaling, the UE obtains the fourth configuration information of the second cell based on the fourth signaling, and reports the obtained fourth configuration information to the network side device.

Optionally, the first signaling received by the UE from the network side device is determined by the network side device based on the fourth configuration information.

Optionally, the “reporting the obtained fourth configuration information to the network side device” may be that the obtained fourth configuration information is directly sent by the UE to the core network through the NAS message, or may be that the obtained fourth configuration information is sent by the UE to the base station through the RRC message, and then is sent by the base station to the core network.

For example, after the UE receives the fourth signaling sent by the network side device, the UE obtains the fourth configuration information of the first cell. Next, the UE sends the obtained fourth configuration information to the network side device. The network side device determines the second cell based on the fourth configuration information, and sends the first signaling to the UE, so that the UE initiates the second RRC connection to the second cell based on the first signaling.

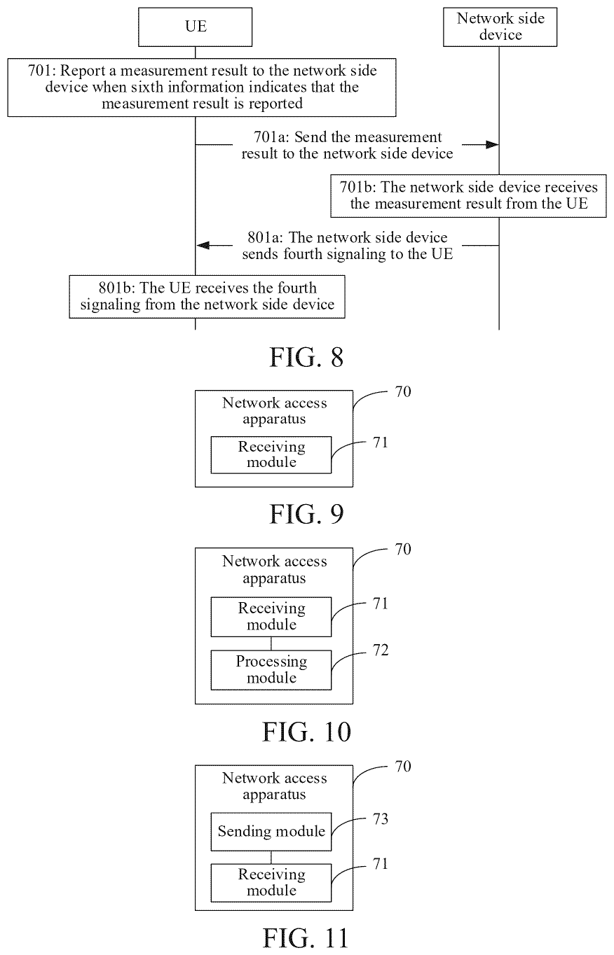

Optionally, in embodiments of this application, referring to FIG. 8, in the network access method provided in embodiments of this application, step 801 above further includes step 801a and step 801b below.

Step 801a: The network side device sends the fourth signaling to the UE.

Step 801b: The UE receives the fourth signaling from the network side device.

In embodiments of this application, the foregoing fourth signaling is used to instruct the UE to report the fourth configuration information of the second cell.

In this way, compared with the UE, the network side device is clearer about which cell is suitable for the UE to perform the second RRC connection. Therefore, the network side device can determine a suitable cell based on the measurement result, and instruct, based on the configuration information reported by the UE, the UE to initiate the second RRC connection to the cell, so that the UE can initiate the second RRC connection to the suitable cell more rapidly, thereby improving the success rate of the second RRC connection of the UE.

Optionally, in this embodiment of this application, the network access method provided in embodiments of this application further includes step 901.

Step 901: The UE performs unified access control (UAC) based on a preset access type and/or access identifier when the network side device instructs the UE to initiate the second RRC connection in a third cell.

Alternately, the UE skips performing the UAC.

Optionally, the foregoing third cell is a cell other than a serving cell of a current first RRC connection of the UE.

Optionally, when the UE initiates the RRC connection to the third cell indicated by the network side device, the UE may not perform the UAC when performing the UAC on the cell (for example, it is assumed that the network side device allows, through negotiation, the UE to initiate access), or a specific access control parameter is set, so that it is easier to pass this access check (for example, the Access category is set to 0), or a specific access control parameter is set, so that the network may independently control an access attempt of a dual steering type (for example, an access category is set to a newly introduced access category for dual steering).

In this way, the UE performs the UAC on the preset access type and/or access identifier, or does not perform the UAC, so that a process of initiating, by the UE, the second RRC connection to the cell is reduced, thereby reducing a delay.

It should be noted that, in this embodiment of this application, when the UE receives the first signaling through the NAS signaling, a UE NAS layer forwards information needed by an AS layer to the UE AS layer when necessary. When the UE receives the first signaling through the RRC, the MAC CE, or the physical layer signaling, the UE AS layer forwards information needed by the NAS layer to the UE NAS layer when necessary. For example, if the third configuration information is received by the UE NAS layer from the core network, the third configuration information is related to measurement of the UE, and a measurement behavior is responsible for the AS layer, the UE NAS layer needs to inform the UE AS layer of all or a part of the third configuration information.

It should be noted that this embodiment of this application further provides negotiation between a core network (CN) and the RAN, to enable the UE to initiate the RRC connection to the first cell.

Specifically, a Dual steering addition negotiation process and a Dual steering release process are included.

The Dual steering addition negotiation process:

Step 1: The core network sends a dual steering addition request to the base station, namely, provides more resources for the UE as second access. Optionally, the core network provides some auxiliary information, which is used by the base station to send a related configuration to the UE when the base station receives a dual steering addition request, for example, a UE capability (a full capability or an available capability), a configuration of allowed second access, or a configuration directly including first 3GPP access.

Step 2: The base station sends a response to the core network. The response may be accepting or rejecting the dual steering addition request.

The Dual steering release process:

When a data volume of the user is relatively small, the core network may initiate the release process. When the foregoing base station is congested, the base station may also initiate the release process. When the UE intends to save energy, the release process may also be initiated. For example, the release process is as follows.

Step 1: The base station initiates a dual steering release process to the core network.

Step 2: The core network sends a response to a base station 1, where the response is used to receive (determine) or reject the dual steering release request.

In this way, the UE may initiate, through negotiation between the core network and the RAN, the RRC connection to the cell obtained through negotiation, to improve a success rate of the RRC connection initiated by the UE to the target cell.

The network access method provided in embodiments of this application may be performed by a network access apparatus. In an embodiment of this application, the network access apparatus provided in embodiments of this application is described by using an example in which the network access apparatus performs the network access method.

FIG. 9 is a possible schematic structural diagram of a network access apparatus involved in an embodiment of this application. As shown in FIG. 9, the network access apparatus 70 may include: a receiving module 71.

The receiving module 71 is configured to receive first signaling from a network side device when the UE has established a first RRC connection, where the first signaling is used to instruct the UE to perform a dual steering operation, and the dual steering operation is used to establish a second RRC connection for the UE.

Optionally, in embodiments of this application, with reference to FIG. 9 and as shown in FIG. 10, the foregoing apparatus 70 further includes a processing module 72. The processing module 72 is configured to receive the first signaling from the network side device, and then establish the second RRC connection based on the first signaling. The processing module 72 is specifically configured to set an RRC connection cause value to a first value when the second RRC connection is initiated, where the RRC connection cause value includes an RRC connection establishment cause value or an RRC connection resume cause value; and the first value is any one of the following: a cause value related to the dual steering operation; or a cause value related to a mobile originated call.

Optionally, in embodiments of this application, the first signaling includes first indication information, and the first indication information is used to instruct or request the UE to initiate the second RRC connection; or the first signaling includes second indication information, and the second indication information is used to indicate a condition for the UE to initiate the second RRC connection.

Optionally, in embodiments of this application, the first signaling includes first configuration information, and the first configuration information is used to assist the UE in determining a first cell that initiates the second RRC connection.

Optionally, in embodiments of this application, the first configuration information includes at least one of the following:
a type of a RAT of a cell;
a frequency of the cell;
ID information of the cell;
a cell type;
PLMN information;
NPN information; or
network capability information of the cell.

Optionally, in embodiments of this application, the network capability information of the cell includes at least one of the following:
first information indicating that the cell supports the dual steering operation; or
second information indicating that the cell supports UE capability change.

Optionally, in an embodiment of this application, the foregoing processing module 72 is further configured to: use, as the first cell, a cell that satisfies the first configuration information; or use, when the first configuration information includes the cell ID information, a cell corresponding to cell ID information as the first cell.

Optionally, in embodiments of this application, the first signaling includes second configuration information. The second configuration information includes at least one of the following:
third information indicating that the network side device supports the dual steering operation; or
fourth information indicating a session steering mode used to perform the dual steering operation.

Optionally, in embodiments of this application, with reference to FIG. 9 and as shown in FIG. 11, the foregoing apparatus 70 further includes a sending module 73. The sending module 73 is configured to send, before the first signaling is received from the network side device, a first request to the network side device when a first condition is satisfied, and the first request is used to request the network side device to send the first signaling; and
the first condition includes at least one of the following:
the UE is in a single-access state and requests to enter a dual steering mode; or
the UE is in a dual steering mode and requests to resume from an abnormal dual steering transmission.

Optionally, in embodiments of this application, the first signaling is further used to indicate at least one of the following:
the UE performs dual steering measurement; or
the UE reports a measurement result of the dual steering measurement.

Optionally, in embodiments of this application, the first signaling further includes third configuration information, where
the third configuration information includes at least one of the following:
measurement interval gap configuration information for performing the dual steering measurement;
fifth information indicating a measurement object;
sixth information indicating whether a measurement result of dual steering is reported; or
a condition for reporting the measurement result.

Optionally, in embodiments of this application, the third configuration information includes sixth information. The foregoing processing module 72 is further configured to: determine a second cell based on the measurement result when the sixth information indicates that the measurement result is not reported, and initiate the second RRC connection to the second cell.

Optionally, in embodiments of this application, the third configuration information includes the sixth information. The foregoing sending module 73 is further configured to report the measurement result to the network side device when the sixth information indicates that the measurement result is reported.

Optionally, in embodiments of this application, the foregoing receiving module 71 is further configured to receive fourth signaling from the network side device after the UE reports the measurement result to the network side device, the fourth signaling is used to instruct the UE to report fourth configuration information of the second cell, and the fourth configuration information is used to establish the second RRC connection.

Optionally, in embodiments of this application, the fourth configuration information includes at least one of the following:
ID information of the second cell;
a RAT type of the second cell;
frequency information of the second cell;
PLMN information of the second cell;
a type of the second cell;
signal quality of the second cell;
a broadcast message of the second cell; or
network capability information of the second cell.

Optionally, in an embodiment of this application, the foregoing processing module 72 is further configured to perform unified access control UAC based on a preset access type and/or access identifier when the network side device instructs the UE to initiate the second RRC connection in a third cell, or skip performing the UAC.

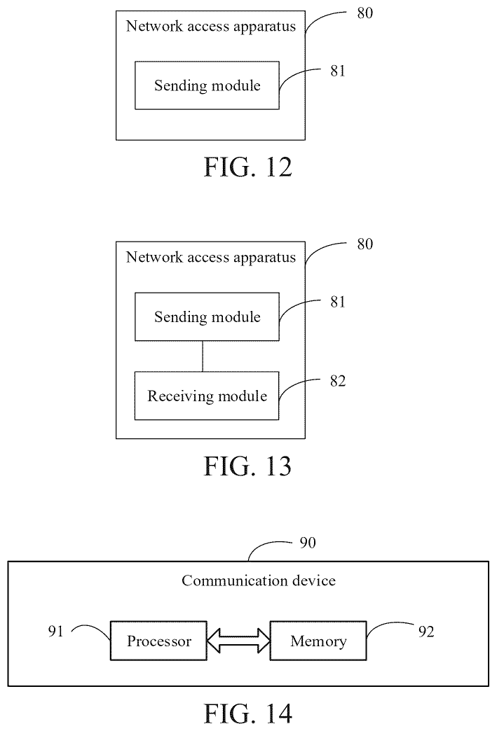

FIG. 12 is another possible schematic structural diagram of a network access apparatus involved in an embodiment of this application. As shown in FIG. 12, the network access apparatus 80 may include a sending module 81.

The sending module 81 is configured to send first signaling to a UE when the UE has established a first RRC connection, where the first signaling is used to instruct the UE to perform a dual steering operation, and the dual steering operation is used to establish a second RRC connection for the UE.

Optionally, in embodiments of this application, the first signaling includes first indication information, and the first indication information is used to instruct or request the UE to initiate the second RRC connection; or the first signaling includes second indication information, and the second indication information is used to indicate a condition for the UE to initiate the second RRC connection.

Optionally, in embodiments of this application, the first signaling includes first configuration information, and the first configuration information is used to assist the UE in determining a first cell that initiates the second RRC connection.

Optionally, in embodiments of this application, the first configuration information includes at least one of the following:
a type of a RAT of a cell;
a frequency of the cell;
ID information of the cell;
a cell type;
PLMN Information;
NPN information; or
network capability information of the cell.

Optionally, in embodiments of this application, the network capability information of the cell includes at least one of the following:
first information indicating that the cell supports the dual steering operation; or
second information indicating that the cell supports UE capability change.

Optionally, in embodiments of this application, the first signaling includes second configuration information. The second configuration information includes at least one of the following:
third information indicating that the network side device supports the dual steering operation; or
fourth information indicating a session steering mode used to perform the dual steering operation.

Optionally, in embodiments of this application, with reference to FIG. 12 and as shown in FIG. 13, the foregoing apparatus 80 further includes a receiving module 82. The receiving module 82 is configured to receive a first request from the UE before the network side device sends the first signaling to the UE, and the first request is used by the UE to request the network side device to send the first signaling.

Optionally, in embodiments of this application, the first signaling is further used to indicate at least one of the following:
the UE performs dual steering measurement; or
the UE reports a measurement result of the dual steering measurement.

Optionally, in embodiments of this application, the first signaling further includes third configuration information, where
the third configuration information includes at least one of the following:
measurement interval gap configuration information for performing the dual steering measurement;
fifth information indicating a measurement object;
sixth information indicating whether a measurement result of dual steering is reported; or
a condition for reporting the measurement result.

Optionally, in embodiments of this application, the third configuration information includes the sixth information. The foregoing receiving module 82 is further configured to receive the measurement result from the UE, and the measurement result is used to determine a second cell.

Optionally, in embodiments of this application, the foregoing sending module 81 is further configured to receive fourth signaling from the network side device after the UE reports the measurement result to the network side device, the fourth signaling is used to instruct the UE to report fourth configuration information of the second cell, and the fourth configuration information is used to establish the second RRC connection.

Optionally, in embodiments of this application, the fourth configuration information includes at least one of the following:
ID information of the second cell;
a RAT type of the second cell;
frequency information of the second cell;
PLMN information of the second cell;
a type of the second cell;
signal quality of the second cell;
a broadcast message of the second cell; or
network capability information of the second cell.

In the network access apparatus provided in embodiments of this application, when the UE has established a first RRC connection, the first signaling is received from the network side device. The first signaling is used to instruct the UE to perform a dual steering operation. The dual steering operation is used to establish a second RRC connection for the UE. In this way, when a resource is congested, the network side device may instruct or request, in time through the first signaling, the UE to perform the dual steering operation, and the UE performs the second RRC connection based on the signaling, to improve a success rate of the second RRC connection and reduce an establishment delay of the second RRC connection.

The network access apparatus in embodiments of this application may be an electronic device, for example, an electronic device having an operating system, or a component in an electronic device, such as an integrated circuit or a chip. The electronic device may be a terminal, or may be another device other than the terminal. For example, the terminal may include but is not limited to the foregoing listed types of the terminal 11. The another device may be a server, a network attached storage (NAS), or the like, which is not specifically limited in embodiments of this application.

The network access apparatus provided in embodiments of this application can implement all processes implemented in the method embodiments of FIG. 2 to FIG. 8, and achieve the same technical effects. To avoid repetition, details are not described herein.

Optionally, as shown in FIG. 14, an embodiment of this application further provides a communication device 90, including a processor 91 and a memory 92. The memory 92 stores a program or instructions executable on the processor 91. For example, when the communication device 90 is a terminal, the program or the instruction, when executed by the processor 91, implements the steps in the foregoing embodiments of the network access method, and can achieve the same technical effect. When the communication device 90 is a network side device, the program or the instruction, when executed by the processor 91, implements the steps of the foregoing embodiments of the network access method, and can achieve the same technical effects. To avoid repetition, details are not described herein again.

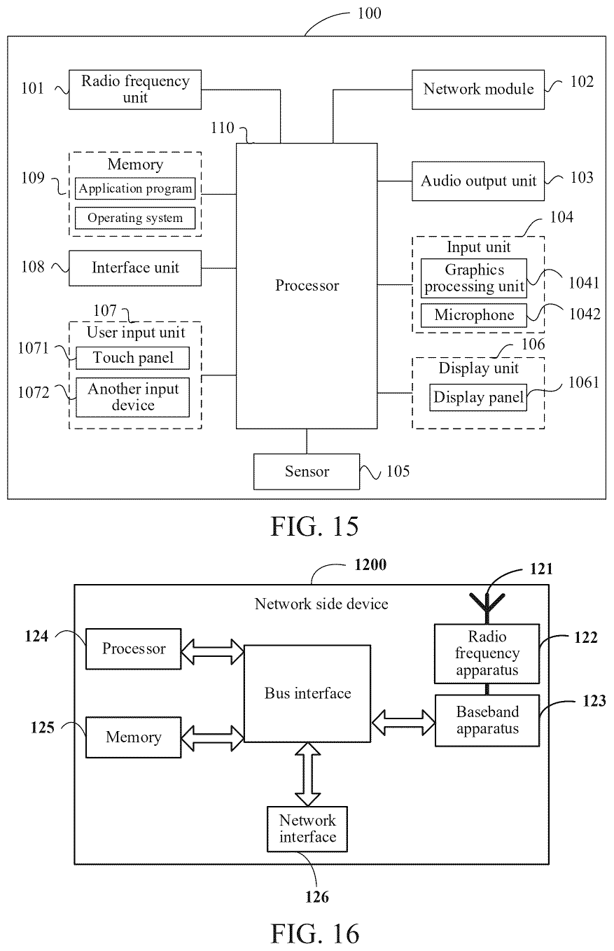

An embodiment of this application further provides a UE, including a processor and a communication interface. The communication interface is coupled to the processor. The processor is configured to run a program or an instruction, to implement the steps of the method embodiment shown in FIG. 15. The terminal embodiment corresponds to the foregoing method embodiment of the terminal side. The implementation processes and implementations of the foregoing method embodiment are all applicable to the terminal embodiment, and can achieve the same technical effect. Specifically, the UE provided in embodiments of this application may be the terminal. FIG. 15 is a schematic diagram of a hardware structure of a terminal for implementing an embodiment of this application.

A terminal 100 includes, but is not limited to, at least some components such as a radio frequency unit 101, a network module 102, an audio output unit 103, an input unit 104, a sensor 105, a display unit 106, a user input unit 107, an interface unit 108, a memory 109, and a processor 110.

A person skilled in the art may understand that the terminal 100 may further include a power supply (for example, a battery) that supplies power to the components. The power supply may be logically connected to the processor 110 through a power management system, thereby implementing functions such as management of charging, discharging, and power consumption through the power management system. The terminal structure shown in FIG. 15 constitutes no limitation on the terminal, and the terminal may include more or fewer components than those shown in the figure, or some merged components, or different component arrangements. Details are not described herein again.

It should be noted that, in this embodiment of this application, the input unit 104 may include a graphics processing unit (GPU) 1041 and a microphone 1042. The graphics processing unit 1041 processes image data of a static picture or a video obtained by an image capturing apparatus (for example, a camera) in a video capturing mode or an image capturing mode. The display unit 106 may include a display panel 1061. The display panel 1061 may be configured in a form such as a liquid crystal display or an organic light-emitting diode. The user input unit 107 includes at least one of a touch panel 1071 or another input device 1072. The touch panel 1071 is also referred to as a touchscreen. The touch panel 1071 may include two parts: a touch detection apparatus and a touch controller. The another input device 1072 may include but is not limited to a physical keyboard, a function button (for example, a volume control button or a power button), a trackball, a mouse, and a joystick. Details are not described herein again.

In this embodiment of this application, the radio frequency unit 101 receives downlink data from a network side device and may provide the downlink data to the processor 110 for processing. In addition, the radio frequency unit 101 may send uplink data to the network side device. Generally, the radio frequency unit 101 includes but is not limited to an antenna, an amplifier, a transceiver, a coupler, a low noise amplifier, a duplexer, and the like.

The memory 109 may be configured to store a software program or an instruction and various data. The memory 109 may mainly include a first storage area for storing a program or an instruction and a second storage area for storing data. The first storage area may store an operating system, an application program or an instruction required for at least one function (such as a sound playback function and an image playback function), and the like. In addition, the memory 109 may include a volatile memory or a non-volatile memory. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synch link dynamic random access memory (Synch link DRAM, SLDRAM), and a direct rambus random access memory (Direct Rambus RAM, DRRAM). The memory 109 in this embodiment of this application includes, but is not limited to, these memories and any other suitable types of memories.

The processor 110 may include one or more processing units. Optionally, the processor 110 integrates an application processor and a modem processor. The application processor mainly processes operations related to an operating system, a user interface, an application program, and the like. The modem processor mainly processes wireless communication signals, and is, for example, a baseband processor. It may be understood that the foregoing modem processor may alternatively not be integrated into the processor 110.

The foregoing radio frequency module 101 is configured to receive first signaling from a network side device when the UE has established a first RRC connection, where the first signaling is used to instruct the UE to perform a dual steering operation, and the dual steering operation is used to establish a second RRC connection for the UE.

Optionally, in embodiments of this application, the foregoing processor 110 is configured to receive the first signaling from the network side device, and then establish the second RRC connection based on the first signaling. The processor 110 is specifically configured to set an RRC connection cause value to a first value when the second RRC connection is initiated, where the RRC connection cause value includes an RRC connection establishment cause value or an RRC connection resume cause value; and the first value is any one of the following: a cause value related to the dual steering operation; or a cause value related to a mobile originated call.

Optionally, in embodiments of this application, the first signaling includes first indication information, and the first indication information is used to instruct or request the UE to initiate the second RRC connection; or the first signaling includes second indication information, and the second indication information is used to indicate a condition for the UE to initiate the second RRC connection.

Optionally, in embodiments of this application, the first signaling includes first configuration information, and the first configuration information is used to assist the UE in determining a first cell that initiates the second RRC connection.

Optionally, in embodiments of this application, the first configuration information includes at least one of the following:
a type of a RAT of a cell;
a frequency of the cell;
ID information of the cell;
a cell type;
PLMN Information;
NPN Information; or
network capability information of the cell.

Optionally, in embodiments of this application, the network capability information of the cell includes at least one of the following:
first information indicating that the cell supports the dual steering operation; or
second information indicating that the cell supports UE capability change.

Optionally, in embodiments of this application, the processor 110 is further configured to: use, as the first cell, a cell that satisfies the first configuration information; or use, when the first configuration information includes the cell ID information, a cell corresponding to cell ID information as the first cell.

Optionally, in embodiments of this application, the first signaling includes second configuration information. The second configuration information includes at least one of the following:
third information indicating that the network side device supports the dual steering operation; or
fourth information indicating a session steering mode used to perform the dual steering operation.

Optionally, in embodiments of this application, the foregoing radio frequency module 101 is further configured to send, before the first signaling is received from the network side device, a first request to the network side device when a first condition is satisfied, and the first request is used to request the network side device to send the first signaling; and
the first condition includes at least one of the following:
the UE is in a single-access state and requests to enter a dual steering mode; or
the UE is in a dual steering mode and requests to resume from an abnormal dual steering transmission.

Optionally, in embodiments of this application, the first signaling is further used to indicate at least one of the following:
the UE performs dual steering measurement; or
the UE reports a measurement result of the dual steering measurement.

Optionally, in embodiments of this application, the first signaling further includes third configuration information, where
the third configuration information includes at least one of the following:
measurement interval gap configuration information for performing the dual steering measurement;
fifth information indicating a measurement object;
sixth information indicating whether a measurement result of dual steering is reported; or
a condition for reporting the measurement result.

Optionally, in embodiments of this application, the third configuration information includes sixth information. The foregoing processor 110 is further configured to: determine a second cell based on the measurement result when the sixth information indicates that the measurement result is not reported, and initiate the second RRC connection to the second cell.

Optionally, in embodiments of this application, the third configuration information includes the sixth information. The foregoing radio frequency module 101 is further configured to report the measurement result to the network side device when the sixth information indicates that the measurement result is reported.

Optionally, in embodiments of this application, the foregoing radio frequency module 101 is further configured to receive fourth signaling from the network side device after the UE reports the measurement result to the network side device, the fourth signaling is used to instruct the UE to report fourth configuration information of the second cell, and the fourth configuration information is used to establish the second RRC connection.

Optionally, in embodiments of this application, the fourth configuration information includes at least one of the following:
ID information of the second cell;
a RAT type of the second cell;
frequency information of the second cell;
PLMN information of the second cell;
a type of the second cell;
signal quality of the second cell;
a broadcast message of the second cell; or
network capability information of the second cell.

Optionally, in embodiments of this application, the foregoing processor 110 is further configured to perform unified access control UAC based on a preset access type and/or access identifier when a network side device instructs the UE to initiate the second RRC connection in a third cell, or skip performing the UAC.

In the terminal provided in embodiments of this application, when the UE has established a first RRC connection, the first signaling is received from the network side device. The first signaling is used to instruct the UE to perform a dual steering operation. The dual steering operation is used to establish a second RRC connection for the UE. In this way, when a resource is congested, the network side device may instruct or request, in time through the first signaling, the UE to perform the dual steering operation, and the UE performs the second RRC connection based on the signaling, to improve a success rate of the second RRC connection and reduce an establishment delay of the second RRC connection.

It may be understood that the implementation process of each implementation in this embodiment may refer to the relevant description of the method embodiments in FIG. 2 to FIG. 6, and the same or corresponding technical effects are achieved. To avoid repetition, details are not described herein again.

An embodiment of this application further provides a network side device, including a processor and a communication interface. The communication interface is coupled to the processor. The processor is configured to run a program or an instruction, to implement the steps of the method embodiment shown in FIG. 2 to FIG. 8. An embodiment of the network side device corresponds to the foregoing method embodiment of the network side device. Each implementation process and implementation of the foregoing method embodiment can be applied to this embodiment of the network side device, and can achieve the same technical effect.

Specifically, an embodiment of this application further provides a network side device. As shown in FIG. 16, the network side device 1200 includes an antenna 121, a radio frequency apparatus 122, a baseband apparatus 123, a processor 124, and a memory 125. The antenna 121 is connected to the radio frequency apparatus 122. In an uplink direction, the radio frequency apparatus 122 receives information through the antenna 121, and sends the received information to the baseband apparatus 123 for processing. In a downlink direction, the baseband apparatus 123 processes to-be-sent information, and sends the processed to-be-sent information to the radio frequency apparatus 122. The radio frequency apparatus 122 processes the received information, and then sends the processed information through the antenna 121.

The method performed by the network side device in the foregoing embodiment may be implemented by the baseband apparatus 123. The baseband apparatus 123 includes a baseband processor.

The baseband apparatus 123 may include, for example, at least one baseband board. A plurality of chips are arranged on the baseband board, as shown in FIG. 16. One of the chips is, for example, a baseband processor, and is connected to the memory 125 through a bus interface to call a program in the memory 125, to perform the operations of the network side device shown in the foregoing method embodiment.

The network side device may further include a network interface 126. The interface is, for example, a common public radio interface (CPRI).

Specifically, the network side device 1200 in embodiments of the present invention further includes an instruction or a program stored in the memory 125 and executable on the processor 124. The processor 124 invokes the instruction or the program in the memory 125 to perform the method performed by each module shown in FIG. 12 and FIG. 13, and achieves the same technical effect. To avoid repetition, details are not described herein again.

An embodiment of this application further provides a readable storage medium. The readable storage medium stores a program or an instruction. The program or the instruction, when executed by a processor, implements the processes of the foregoing embodiments of the network access method, and can achieve the same technical effect. To avoid repetition, details are not described herein again.

The processor may be a processor of the terminal in the foregoing embodiments. The readable storage medium includes a computer-readable storage medium, such as a computer read-only memory (ROM), a random access memory (RAM), a magnetic disk, or an optical disk. In some examples, the readable storage medium may be a non-transitory readable storage medium.

An embodiment of this application further provides a chip. The chip includes a processor and a communication interface. The communication interface is coupled to the processor. The processor is configured to run a program or an instruction, to implement the processes of the foregoing embodiments of the network access method, and can achieve the same technical effect. To avoid repetition, details are not described herein again.

It should be understood that the chip in this embodiment of this application may also be referred to as a system level chip, a system chip, a chip system, a system on chip, or the like.

An embodiment of this application further provides a computer program/program product. The computer program/program product is stored in a storage medium. The computer program/program product is executed by at least one processor to implement the processes of the foregoing embodiments of the network access method, and can achieve the same technical effect. To avoid repetition, details are not described herein again.

It should be noted that in this specification, terms “comprise”, “include” or any other variants herein are intended to encompass non-exclusive inclusion, so that a process, a method, an article, or an apparatus including a series of elements not only include those elements, but also includes another element not listed explicitly or includes intrinsic elements for the process, the method, the article, or the apparatus. Without any further limitation, an element defined by a phrase “include one . . . ” does not exclude existence of an additional same element in the process, the method, the article, or the apparatus that includes the element. In addition, it should be noted that the scope of the method and the apparatus in the implementations of this application is not limited to function execution in the order shown or discussed, and may further include function execution in a substantially simultaneous manner or in a reverse order based on the involved functions. For example, the described method may be performed in an order different from the described order, and various steps may also be added, omitted, or combined. In addition, features described with reference to some examples may be combined in another example.

According to the descriptions of the foregoing implementations, a person skilled in the art may clearly learn that the method in the foregoing embodiments may be implemented by a computer software product with a necessary universal hardware platform, or may be implemented by hardware. The computer software product is stored in a storage medium (for example, a ROM, a RAM, a magnetic disk, or an optical disc) and includes several instructions, to enable the terminal or the network side device to perform the method in embodiments of this application.

Although embodiments of this application are described above with reference to the accompanying drawings, this application is not limited to the foregoing specific implementations. The foregoing specific implementations are illustrative only but not restrictive. With the enlightenment of this application, a person of ordinary skill in the art may make many forms of implementations without departing from the concept of this application and the protection scope of the claims. These implementations fall within the protection of this application.

What is claimed is:

1. A network access method, applied to a user equipment (UE), and comprising:
receiving first signaling from a network side device when the UE has established a first radio resource control (RRC) connection, wherein the first signaling is used to instruct the UE to perform a dual steering operation, and the dual steering operation is used to establish a second RRC connection for the UE.

2. The method according to claim 1, wherein after the receiving first signaling from the network side device, the method further comprises:
establishing, by the UE, the second RRC connection based on the first signaling; and
the establishing, by the UE, the second RRC connection comprises:
setting an RRC connection cause value to a first value when the second RRC connection is initiated, wherein
the RRC connection cause value comprises an RRC connection establishment cause value or an RRC connection resume cause value; and
the first value is any one of the following:
a cause value related to the dual steering operation; or
a cause value related to a mobile originated call.

3. The method according to claim 1, wherein the first signaling comprises first indication information, and the first indication information is used to instruct or request the UE to initiate the second RRC connection; or
the first signaling comprises second indication information, and the second indication information is used to indicate a condition for the UE to initiate the second RRC connection.

4. The method according to claim 1, wherein the first signaling comprises first configuration information, and the first configuration information is used to assist the UE in determining a first cell that initiates the second RRC connection.

5. The method according to claim 4, wherein the first configuration information comprises at least one of the following:
a type of a radio access technology (RAT) of a cell;
a frequency of the cell;
cell identity (ID) information;
a cell type;
public land mobile network (PLMN) information;
non-public network (NPN) information; or
network capability information of the cell.

6. The method according to claim 5, wherein the network capability information of the cell comprises at least one of the following:
first information indicating that the cell supports the dual steering operation; or
second information indicating that the cell supports UE capability change.

7. The method according to claim 4, further comprising:
using, as the first cell by the UE, a cell that satisfies the first configuration information;
or
using, when the first configuration information comprises a cell ID information, a cell corresponding to cell ID information as the first cell.

8. The method according to claim 1, wherein the first signaling comprises second configuration information, and the second configuration information comprises at least one of the following:
third information indicating that the network side device supports the dual steering operation; or
fourth information indicating a session steering mode used to perform the dual steering operation.

9. The method according to claim 1, wherein before the receiving first signaling from the network side device, the method further comprises:
sending, by the UE, a first request to the network side device when a first condition is satisfied, wherein the first request is used to request the network side device to send the first signaling; and
the first condition comprises at least one of the following:
the UE is in a single-access state and requests to enter a dual steering mode; or
the UE is in the dual steering mode and requests to resume from an abnormal dual steering transmission.

10. The method according to claim 1, wherein the first signaling is further used to indicate at least one of the following:
the UE performs dual steering measurement; or
the UE reports a measurement result of the dual steering measurement.

11. The method according to claim 10, wherein the first signaling further comprises third configuration information; and
the third configuration information comprises at least one of the following:
measurement interval gap configuration information for performing the dual steering measurement;
fifth information indicating a measurement object;
sixth information indicating whether the measurement result of dual steering is reported; or
a condition for reporting the measurement result.

12. The method according to claim 11, wherein the third configuration information comprises the sixth information, and the method further comprises:
determining, by the UE, a second cell based on the measurement result when the sixth information indicates that the measurement result is not reported, and initiating the second RRC connection to the second cell.

13. The method according to claim 11, wherein the third configuration information comprises the sixth information, and the method further comprises:
reporting, by the UE, the measurement result to the network side device when the sixth information indicates that the measurement result is reported.

14. The method according to claim 13, wherein after the reporting, by the UE, the measurement result to the network side device, the method further comprises:
receiving, by the UE, fourth signaling from the network side device, wherein the fourth signaling is used to instruct the UE to report fourth configuration information of a second cell, and the fourth configuration information is used to establish the second RRC connection.

15. The method according to claim 14, wherein
the fourth configuration information comprises at least one of the following:
ID information of the second cell;
a RAT type of the second cell;
frequency information of the second cell;
PLMN information of the second cell;
a type of the second cell;
signal quality of the second cell;
a broadcast message of the second cell; or
network capability information of the second cell.

16. The method according to claim 1, further comprising:
performing, by the UE, unified access control (UAC) based on a preset access type and/or access identifier when the network side device instructs the UE to initiate the second RRC connection in a third cell; or
skipping performing, by the UE, the UAC.

17. A non-transitory computer readable storage medium, storing a program or an instruction, wherein the program or the instruction, when executed by a processor, implements the network access method according to claim 1.

18. A network access method, applied to a network side device, and comprising:
sending, by the network side device, first signaling to a user equipment (UE) when the UE has established a first radio resource control (RRC) connection, wherein
the first signaling is used to instruct the UE to perform a dual steering operation, and the dual steering operation is used to establish a second RRC connection for the UE.

19. The network side device, comprising a processor and a memory, wherein the memory stores a program or an instruction executable on the processor, and the program or the instruction, when executed by the processor, implements the steps of the network access method according to claim 18.

20. A user equipment (UE), comprising a processor and a memory, wherein the memory stores a program or an instruction executable on the processor, and the program or the instruction, when executed by the processor, causes the UE to:
receive first signaling from a network side device when the UE has established a first radio resource control (RRC) connection, wherein the first signaling is used to instruct the UE to perform a dual steering operation, and the dual steering operation is used to establish a second RRC connection for the UE.
